(19) United States
(12) Patent Application Publication
(10) Pub. No.: US 2008/0319878 A1
(43) Pub. Date: Dec. 25, 2008

(54) Dynamic Time Series Update Method

(76) Inventors: Thorsten Glebe, Leimen (DE); Hans-Georg Reusch, Wiesenbach (DE); Volkmar Soehner, Sinsheim (DE); Andrei Suvernev, Palo Alto, CA (US)

Correspondence Address: MINTZ, LEVIN, COHN, FERRIS, GLOVSKY & POPEO, P.C.;ATTN: PATENT INTAKE CUSTOMER NO. 64280, ONE FINANCIAL CENTER, BOSTON, MA, 02111, US

(21) Appl. No.: 11/767,337

(22) Filed: Jun. 22, 2007

(51) Int. Cl. G06Q 10/00; G06F 17/30

(52) U.S. Cl. 705/28

(57) ABSTRACT

Updating metadata for a set of time series quantity data, and re-creating the set of time series quantity data in response to updating the metadata while reading at least one of the set of time series quantity data.

### FIELD OF INVENTION

The field of invention relates generally to the software arts, and, more specifically, to parallel time interval processing.

### BACKGROUND

A “time series” tracks the quantity of an item or resource over time at a particular location. For example, in the case of a supply chain management software application, a time series for a particular item may be used to track, the daily change of the quantity that a location such as a warehouse has “in stock” for the particular item. Here, the time series would track the “ups and downs” in the quantity of the item in the warehouse in response to various deliveries/shipments of the item to/from the warehouse that occur over the time period.

A typical supply chain management process involves the accessing of time series data to check the availability of an item or resource. For example, again using a warehouse example, if a transaction desires to ship “X” amount of a specific item at a certain time, the supply chain management software will “check” that at least X items will be in the warehouse on that day.

With reference to FIG. 1, an Available To Promise (ATP) time series can be configured to accommodate a certain business scenario. In an ATP time series 100, one or more discontiguous time intervals, also known as “time series buckets” or simply “buckets”, may be linked to a product-location combination by a key. For example, time series 106, 107, 108 and 109 are linked to product-location key A 130, whereas time series 111 is linked to product-location key B 140, time series 116,117 are linked to product-location key C 150, and time series 121 is linked to product-location key D 160. Each product-location key, such as product-location key A 130, product-location key B 140, product-location key C 150 and product-location key D 160, identifies a unique respective product-location 105, 110, 115 and 120.

A set of time series may be linked by product-location key to a particular product-location. One time series in the set may relate to receive orders for the product at that location, while another time series in the set may relate to demand orders for the product at the same location. Too, there may be sublocations for the product at a location, each of which may be represented by a separate time series in the set. A time series key 166-173 identifies a time series with respect to its product-location, sublocation and/or other key elements 180-187 (e.g. batch or order category). The time series key is the combination of the product location key (key A 130, key B 140, key C 150, key D 160), and the key elements 166-173 (key 1, key 2, key 3 . . . ).

Each time series bucket has an associated time key (also referred to as a bucket key). For example, the tuples {t1, data1}, {t2, data2} in FIG. 1 . . . indicate a respective time series bucket with bucket key t1 190, t2 192 and the bucket data data1 193, data2 194 in time series 106. Tuple {t9, data9} at 195 represents a time bucket for data9 in time series 111, and tuples {t11, data11}, {t13, data13} and {t15, data15} represent time buckets corresponding to the data data11, data13 and data15 in respective time series 116, 117 and 121.

Each product-location maintains parameter data for a set of time series linked by a product-location key to the product-location. Multiple sets of parameter data can exist, one set for each product-location, and the set is linked to the product-location by the product-location key. For example, parameter data A1 131, A2 132 A3 133 are linked via product-location key A 130 with time series 106-109, while parameter data B1 141, B2 142, B3 143 are assigned to time series 111 via the product-location key B. Similarly, parameters for product-locations 115 and 120 are respectively assigned to the time series that are linked to those product-locations.

The parameter data describes the properties of the set of time series, as well as the data stored in the time series, at the same product-location. Such properties include but are not limited to the product-location, time zone at the location, number of buckets per day (i.e., size of the buckets), for the time series. For example, FIG. 1 illustrates parameters B1 141, B2 142 and B3 143 linked to product-location 110 via product-location key B 140. These parameters define properties of time series 111 also linked to product-location 110 via product-location key B 140, which is part of the primary key of the time series.

Data in a time series may be updated at any time. A change to the parameter data linked to a particular product-location invalidates all the data in a time series to which the parameter data is assigned. Each product-location maintains a way, such as dirty flag, to indicate such. Dirty flag 135 at product-location 105 is set to indicate a change in one of parameters A1 131, A2 132 or A3 133 assigned to time series 106-109 in the same location. Likewise, dirty flag 145 is set to indicate a change to one of the parameters assigned to time series 111 in product-location 110, and so forth.

The ATP time series data is metadata created from order data obtained from an underlying data store, and the assigned parameter data. This metadata is useful, for example, to quickly determine order availability of goods. End user transactions, such as order creation/deletion or order modification (of ATP time series relevant information, e.g., category, sublocation, batch, time, quantity), result in an update of the corresponding ATP time series data. Scheduling of activities (e.g., orders) in supply chain management (SCM) software can lead to a modification of the ATP relevant times or quantities and results in an update of the ATP time series, too. In SCM, orders can be created/modified by parallel (i.e., concurrently executing) end user transactions. The ATP time series are able to handle parallel updates, therefore no lock problems occur. However, updating ATP parameter data invalidates the corresponding ATP time series data, which must then be rebuilt. Rebuilding the corresponding invalidated ATP time series data while parallel end user transactions continue to add or change order data in the ATP time series is a non-trivial task, as the content of ATP time series data is influenced by the parallel transactions. For example, parallel end user transactions may have been started but not yet committed at the time of starting to update corresponding ATP time series data.

Previously, and with reference to FIG. 2, updating parameter data was realized in a “single user mode”. In one implementation, the process 200 involves waiting until any pending end user transactions 205,206, have been committed to the orders database, at times 207 and 208, then enabling “single user mode” at time t₀ 210 which prohibits initiation of any parallel transactions (“order processing inhibited” 225). The parameter (“configuration”) data is modified after time to, for example, at time 215. The process then continues by rebuilding the ATP time series data assigned to the modified parameter data during time period 220. Once the rebuilding of the ATP time series is complete at 230, the database is committed and multi-user mode is re-enabled at time t1 235, at which point in time, end user transactions such as transaction 240 can begin accessing the time series data again.

The motivation for single user mode was that parallel updates of orders via end user transactions, while parameter data was being changed, led to inconsistent ATP time series data, since “old” end user transactions may already exist which operate with their “consistent view” of (outdated) parameter data (for an explanation of “consistent view” see below). (An existing transaction may have operated based on the values of time series quantity and parameter data at the time the transaction started. Thus, transactions with different start times may have different “consistent views”). What is needed is a process for rebuilding the time series data that avoids having to shut down end user transactions that process orders.

A supply chain planning system can be used in connection with a database that provides a “consistent view” for accessing the data in the database. In this context, “consistent view” means that each session/transaction has a view on the underlying data which is given by the committed state of the data at the time when the current transaction has started. Even committed data changes (creation, deletion, modification) performed by parallel transactions are invisible as long as no commit or rollback (or explicit “refresh” of consistent view) has occurred in the current session. Only changes on this initial consistent view done by the transaction itself are visible within the transaction. This arrangement ensures that data is stable and consistent for the planning algorithms used in the current session. Otherwise, either concurrent changes would disturb the planning algorithm while running or it would be necessary to lock all relevant data at the beginning of the current session, leading to massive serialization. Each change of a data object requires the acquisition of an exclusive logical “lock” on the object which prevents concurrent transactions from changing the object in parallel. The set of locks held by a transaction can be released automatically at the end of transaction (commit or rollback). A lock cannot be acquired by a transaction if another parallel transaction already holds the lock (lock collision situation). An example for such a database with consistent view as described herein is the SAP liveCache technology used by SAP in the SAP SCM application.

If the database used in the planning system does not support a consistent view in the manner described above it is also possible to realize it on an application level, for example, by using typical client-server techniques like reading all necessary data at start of a planning transaction into a local buffer and working in this “sandbox” until the live data are updated from the buffer at the end of transaction. For purposes of this disclosure, this arrangement is also referred to as “consistent view”.

The solution presented here is applicable under the assumption that the transactions of the planning system make use of any kind of “consistent view” as described above. Whether the consistent view mechanism is provided “natively” by the underlying database or whether it is implemented on the application level (e.g. by using a special framework or a set of programming rules) does not matter.

### BRIEF DESCRIPTION OF THE DRAWINGS

A better understanding of the present invention can be obtained from the following detailed description in conjunction with the following drawings, in which:

FIG. 1 illustrates a number of sets of time series data and the corresponding configuration data.

FIG. 2 illustrates a prior art method to update time series data.

FIG. 3 illustrates a timing diagram in accordance with an embodiment of the invention.

FIGS. 4A and 4B illustrate a flow chart of a method in accordance with an embodiment of the invention.

FIG. 5 illustrates a timing diagram in accordance with an embodiment of the invention.

FIG. 6 illustrates a timing diagram in accordance with an embodiment of the invention.

FIG. 7 illustrates a timing diagram in accordance with an embodiment of the invention.

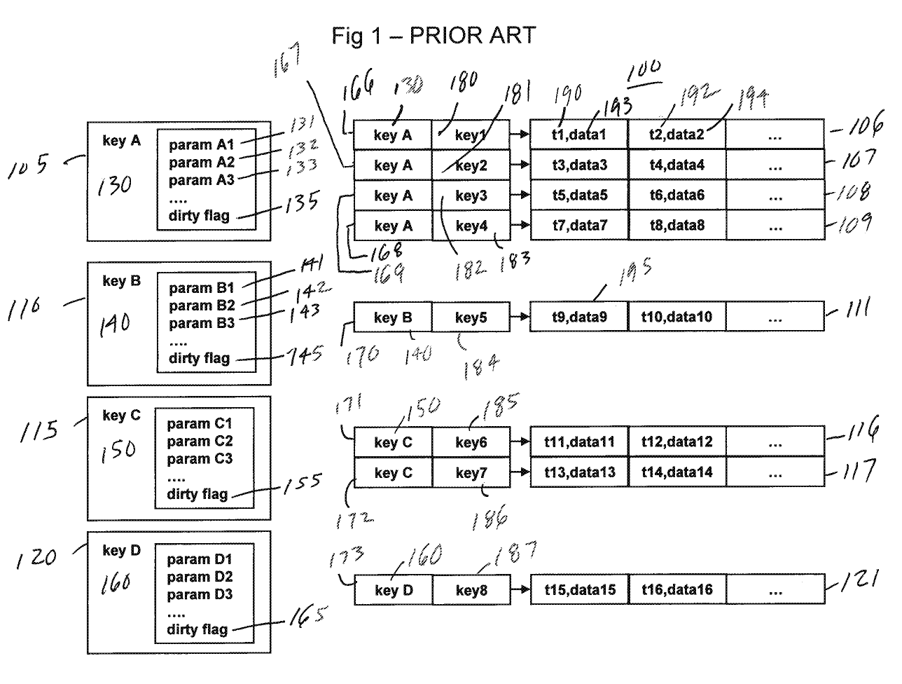

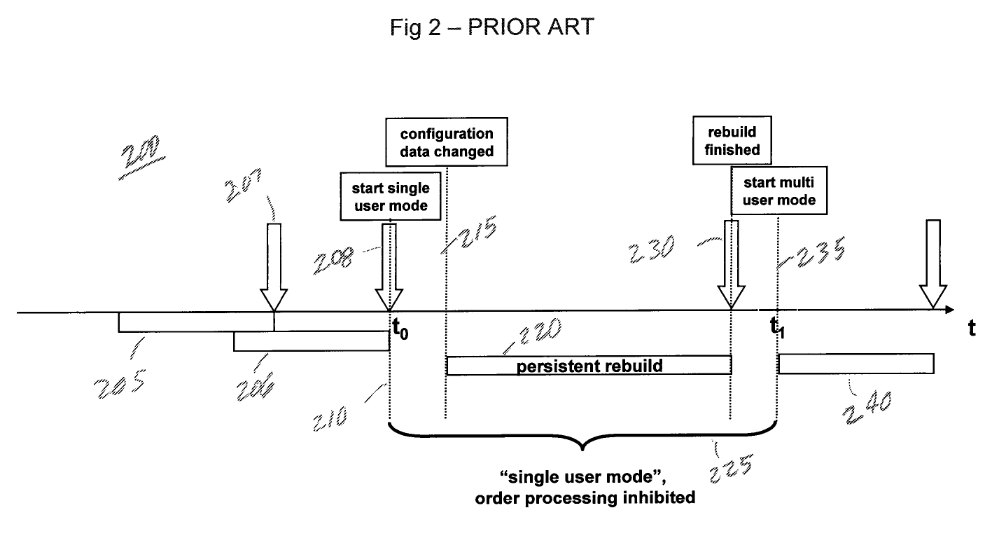

### DETAILED DESCRIPTION

In accordance with one embodiment of the invention, the process of modifying parameter data assigned to a set of one or more persistent time series is separated from the process of rebuilding the corresponding time series. One or more parameters in a set of parameters assigned to a set of time series is modified, for example, as part of an administrative database procedure or transaction. The corresponding time series is marked as dirty to indicate it is invalid in view of the one or more modified parameters. The parameter data, once successfully modified, is committed to the database.

The administrative transaction that modifies the parameter data may be unsuccessful in the event a previous administrative transaction is already modifying the parameter data, in which case, the subsequent administrative process is terminated and any changes made to the parameter data are rolled back, that is, reversed. The dirty flag is part of the database object which contains the parameter data (105, 110, 115, 120), therefore the dirty flag is set within the same database operation which updates the configuration data. Thus the administrative transaction is not able to modify the parameter data and the dirty flag, because the corresponding database object is locked by the first administrative transaction.

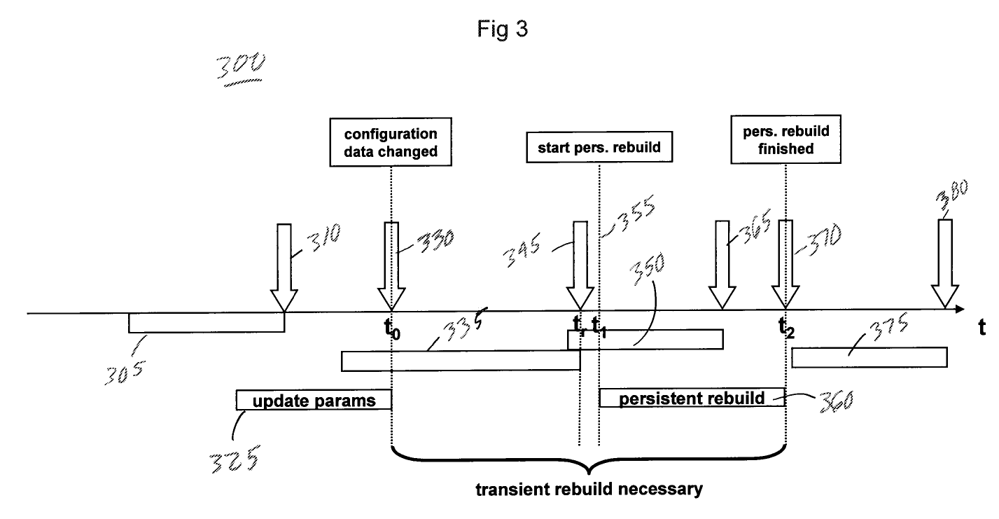

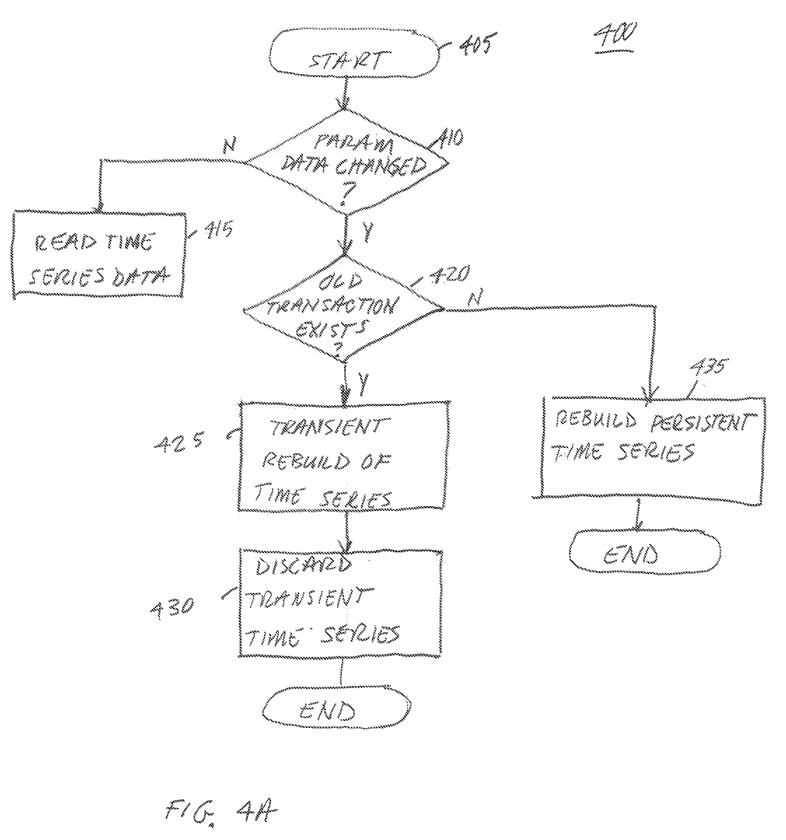

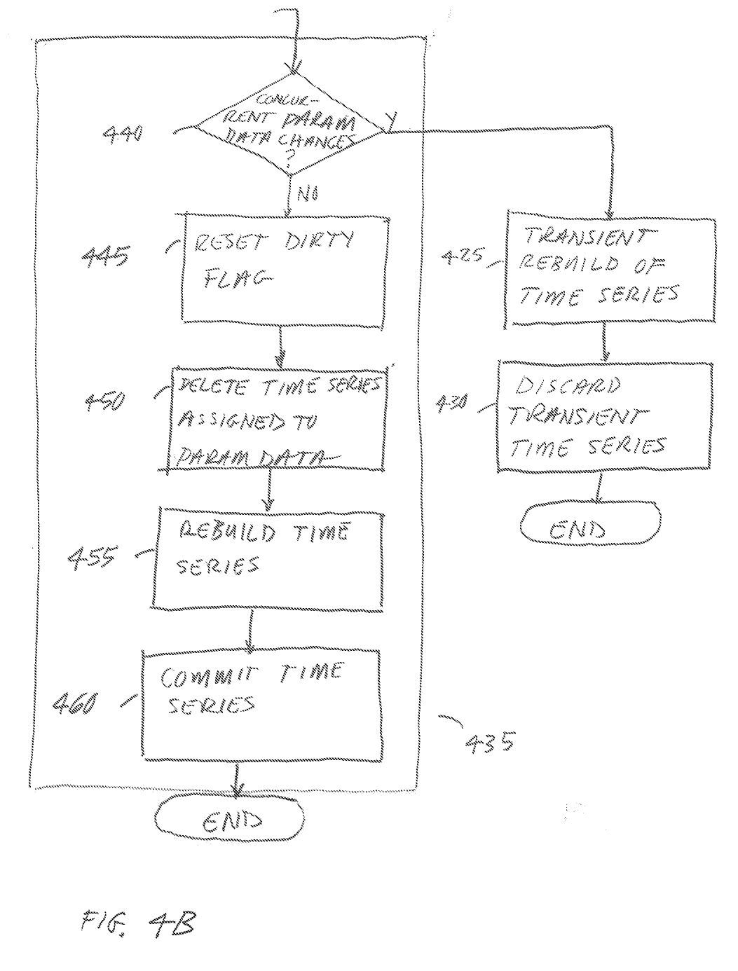

With reference to FIGS. 3, 4A and 4B, a detailed description of an embodiment of the invention is provided. In accordance with one embodiment, rebuilding of persistent time series data is delayed until the first end user transaction attempts to read time series data after it has been changed by an administrative transaction, as detected by the dirty flag associated with the time series data being set.

Beginning at 405, an end user transaction reads a time series and checks at 410 whether parameter data assigned to the time series has been changed. If parameter data has been modified, the dirty flag associated with the time series and assigned parameter data will have been set. If the dirty flag is set, the end user transaction will attempt to rebuild the persistent time series corresponding to the changed parameter data. With reference to the timing diagram 300 illustrated in FIG. 3, end user transaction 305 reads a time series after detecting the dirty flag for the corresponding parameter data is not set, and commits at 310.

While end user transaction 305 is executing, a separate, independent, administrative process 325 changes one or more parameters (configuration data) assigned to the same time series accessed by end user transaction 305, and commits such changes at 330 (time t₀). End user transaction 335 begins executing before administrative process 325 commits changes to the parameter data assigned to the same time series being accessed by transaction 335 and sets the dirty flag, and so reads the time series in the same set as transaction 305.

End user transaction 350, however, starts on or after the time that the changes to parameter data have been committed and the dirty flag set at 330 (on time t₀), and so detects at 410 that the dirty flag is set. At 420, end user transaction 350 checks whether a parallel end user transaction still exists which has the old view of the parameter data. (This information can be provided by the underlying database, e.g. by evaluating whether there are other consistent views which uses older versions of the database object). Indeed, end user transaction 335 began executing prior to modifications to the parameter data being committed at 330, and still exists at the point in time that end user transaction 350 begins executing. Moreover, end user transaction 335's consistent view is based on old parameter data. Thus, a rebuild of the time series cannot be performed at this point in time. Instead, at 425, the time series for end user transaction 350 is built up transiently, that is, the time series is built up in random access memory (RAM) associated with end user transaction 350. At the end of the transaction (at 365) the transient time series are discarded. The persistent time series remains in the dirty state from time 330 (time to). Finally, at 345 (time tᵣ), the “old” transaction 335 completes execution. It should be noted that time tᵣ cannot be predetermined, however the probability that old transactions will terminate increases with time.

In case transaction 350 is not only reading but also updating persistent time series, the updates will be written to the dirty time series. Due to the parallel mechanism of the time series the update will not be written immediately into the time series but merged into the time series anytime after time t₂ 370 when the rebuild by transaction 360 has finished.

End user transaction 360 begins at time 355 (time t₁), and checks at 410 whether parameter data has been changed, and noting the dirty flag remains set, checks at 420 whether any old transactions exist. By the point in time end user transaction 360 begins executing, no transactions with an outdated view on the configuration parameters exist—transaction 335 completed execution at 345 (time tᵣ<time t₁). End user transaction 360 is the first end user transaction to begin executing after any and all parallel transactions with an outdated view of the configuration data have ended executing (transaction 350 started before transaction 360 but has a current view on the configuration data), and so begins at 435 rebuilding the persistent time series belonging to the current parameter data set assigned to the time series accessed by end user transaction 360.

With reference to FIG. 4B, rebuilding the time series comprises the steps of resetting the dirty flag at 445, clearing or deleting the time series to which the parameter data set is assigned at 450, rebuilding the time series (for example, from “orders” data obtained from the database) at 455, and then committing the time series as well as the configuration parameters object (including the updated dirty flag) at 460, at which point in time 370 the time series becomes visible to transactions starting after time t₂ such as end user transaction 375. Finally, at 380, end user transaction 375 commits.

The rebuilding of the persistent time series described above assumes no previous end user transaction has begun updating the parameter data in parallel. Thus, at 440 before resetting the dirty flag, the current end user transaction locks the configuration parameter database object at 440 (the lock is granted if no concurrent transaction changes the configuration parameters) and continues on to steps 445 through 460 as described, otherwise, the end user transaction performs a transient rebuild of the time series at 425 and then discards the transient time series at the end of the end user transaction, at 430.

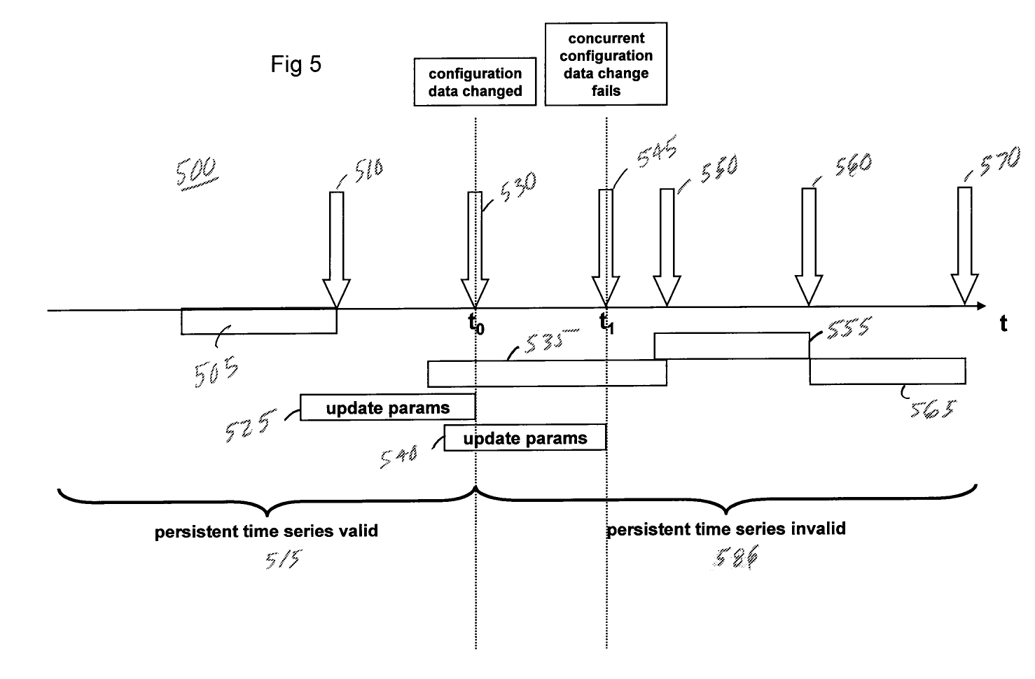

FIG. 5 illustrates another timing diagram 500 according to one embodiment of the invention. End user transaction 505 reads time series and commits at 510. The dirty flag associated with the time series is not set since no modification of the accompanying parameter data has been completed. Administrative transaction 525 begins executing after transaction 505 begins executing, and modifies one or more parameters assigned to the time series accessed by the end user transactions in this example. At time 530, the administrative transaction commits the changes to the parameter data, and the changed time series parameter data is made available. The corresponding time series are marked “dirty” by virtue of the dirty flag which is set and committed together with the parameter data. Beginning at time 530, new end user transactions cannot use persistent time series any further since the series is invalid.

A concurrent administrative transaction 540 begins executing after administrative transaction 525 begins, and more importantly, before administrative transaction 525 commits, and thus changes to parameter data made by transaction 540 fail at time t1 545.

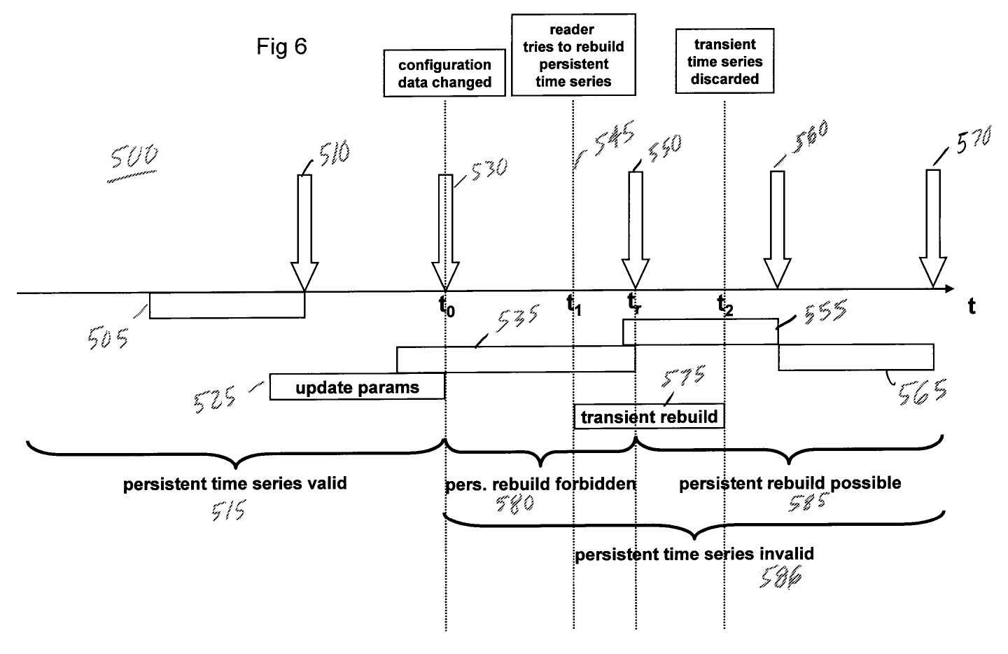

FIG. 6 illustrates further aspects of the timing diagram 500 according to one embodiment of the invention. At time t1 545, an end user transaction 575 initiates rebuilding the dirty time series. However, given old transaction 535 still exists, and that such transaction started executing before administrative transaction 525 committed the changed parameter data and set the dirty flag, transaction 575 may only transiently rebuild the time series, and the persistent time series remains invalid. Indeed, until transaction 535 ends at time 550 (time tᵣ), persistent rebuilding of the time series is forbidden as indicated at 580. Transaction 555 likewise may only transiently rebuild the time series, and then discard the same when the transaction ends at 560, as it too started executing while old transaction 535 still existed.

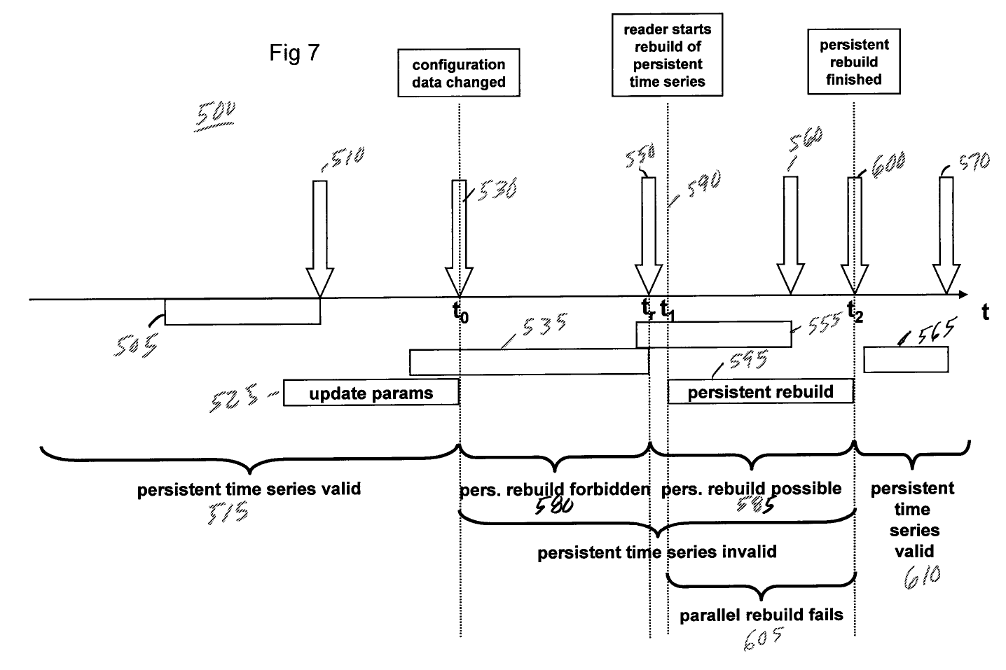

FIG. 7 illustrates yet further aspects of timing diagram 500 according to an embodiment of the invention. After time 550 (time tᵣ), persistent rebuilding of the time series is possible, given termination by time 550 of the old transaction 535. End user transaction 595, beginning at time 590 (time t₁ in FIG. 7), can rebuild the dirty time series since it is the first reader process to initiate such after any and all old transactions that existed before the time series became dirty no longer exist. After transaction 595 rebuilds the time series, the dirty flag is reset. The persistent time series reflects all transactional data committed before time 590 (time t₁) and this new persistent time series become available at time 600 (time t₂). All updates of the time series caused by parallel transactions started after time 530 are handled by the parallel time series and merged into the persistent time series by reading transactions started after transaction 595 has been committed at time 600. Thus, transaction 565 has access to such persistent time series and is able to merge the updates of transaction 555 into the persistent time series which have been rebuilt by transaction 595. Any parallel processes started after time 590 fail to persistently rebuild given transaction 595 is handling the persistent rebuild. Such subsequent parallel processes instead perform a transient rebuild of the time series, which is discarded at the end of such processes.

In the embodiments described, rebuilding of time series in many product-locations can be initiated at the same time by parallel reading transactions. The most used product-locations rebuild their time series first, and unused product-locations will not recreate their time series. Advantageously, no system or database shutdown is needed in accordance with the described embodiments, and there is no impact on processing transactional data that creates, modifies, or deletes orders, since such transactions are not influenced by the parallel updating of parameter data. Furthermore, a reader process can always determine a consistent view of the time series, even when the persistent time series are dirty or in the state of being rebuilt by a parallel transaction.

The processes described above may be performed with program code such as machine-executable instructions which cause a machine (such as a “virtual machine”, a general-purpose processor disposed on a semiconductor chip or special-purpose processor disposed on a semiconductor chip) to perform certain functions. Alternatively, these functions may be performed by specific hardware components that contain hardwired logic for performing the functions, or by any combination of programmed computer components and custom hardware components.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

It is believed that the processes described above can be practiced within various software environments such as, for example, object-oriented and non-object-oriented programming environments, Java based environments (such as a Java 2 Enterprise Edition (J2EE) environment or environments defined by other releases of the Java standard), or other environments (e.g., a NET environment, a Windows/NT environment each provided by Microsoft Corporation).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method, comprising:
updating metadata for a set of time series data, and
re-creating the set of time series data in response to updating the metadata while
accessing at least one of the set of time series data.

2. The method of claim 1 wherein accessing at least one of the set of time series data is performed by a concurrent transaction.

3. The method of claim 2, wherein accessing at least one of the set of time series data is responsive to an updating of a corresponding order data.

4. A method comprising:
modifying a parameter assigned to a set of time series data; and,
invalidating the time series data to which the parameter data is assigned.

5. The method of claim 4 wherein modifying the parameter comprises modifying the parameter unless a concurrent transaction is modifying or has modified the parameter.

6. The method of claim 4, further comprising:
identifying the set of time series data to invalidate responsive to modifying the parameter assigned to the set of time series data;
accessing at least one of the set of time series data via a transaction;
checking for an existence of a concurrent transaction that started before committing the parameter change and that is accessing or may access the at least one of the set of time series data; and
recreating the set of time series data if no such concurrent transaction exists.

7. The method of claim 6 wherein if a concurrent transaction exists, a reading transaction is transiently recreating the set of time series data.

8. The method of claim 6 further comprising, if the concurrent transaction exists, writing via an updating transaction into the set of time series data identified to invalidate such that the writing is merged after the concurrent transaction is committed.

9. The method of claim 6, wherein recreating the set of time series data is prevented if a concurrent transaction with the properties described in claim 6 exist which recreates the same set of time series data.

10. The method of claim 6 wherein recreating the set of times series data comprises:
resetting the identified set of time series data;
rebuilding the identified set of time series data; and
committing the rebuilt identified set of time series data to a persistent store.

11. The method of claim 10, wherein resetting the identified set of time series data comprises:
resetting a flag identifying the set of time series data as dirty; and clearing the set of time series data.

12. An article of manufacture, comprising:
a computer readable medium including instructions that when executed by a computer, cause the computer to perform the following method:
updating metadata for a set of time series data, and
re-creating the set of time series data in response to updating the metadata while accessing at least one of the set of time series data.

13. The article of manufacture of claim 12 wherein accessing at least one of the set of time series data is performed by a concurrent transaction.

14. The article of manufacture of claim 13, wherein accessing at least one of the set of time series data is responsive to an updating of a corresponding order data.

15. An article of manufacture, comprising:
a computer readable medium including instructions that when executed by a computer, cause the computer to perform the following method:
modifying a parameter assigned to a set of time series data; and,
invalidating the time series data to which the parameter data is assigned.

16. The article of manufacture of claim 15 wherein modifying the parameter comprises modifying the parameter unless a concurrent transaction is modifying or has modified the parameter.

17. The article of manufacture of claim 13, further comprising:
identifying the set of time series data to invalidate responsive to modifying the parameter assigned to the set of time series data;
accessing at least one of the set of time series data via a transaction;
checking for an existence of a concurrent transaction that started before committing the parameter change and that is accessing or may access the at least one of the set of time series data; and
recreating the set of time series data if no such concurrent transaction exists.

18. The article of manufacture of claim 17 wherein if a concurrent transaction exists, a reading transaction is transiently recreating the set of time series data.

19. The article of manufacture of claim 17 further comprising, if the concurrent transaction exists, writing via an updating transaction into the set of time series data identified to invalidate such that the writing is merged after the concurrent transaction is committed.

20. The article of manufacture of claim 17, wherein recreating the set of time series data is prevented if a concurrent transaction with the properties described in claim 6 exist which recreates the same set of time series data.

21. The article of manufacture of claim 17 wherein recreating the set of times series data comprises:
resetting the identified set of time series data;
rebuilding the identified set of time series data; and
committing the rebuilt identified set of time series data to a persistent store.

22. The article of manufacture of claim 21, wherein resetting the identified set of time series data comprises:
resetting a flag identifying the set of time series data as dirty; and clearing the set of time series data.
